(19) United States
(12) Patent Application Publication
(10) Pub. No.: US 2008/0081764 A1
(43) Pub. Date: Apr. 3, 2008

(54) Heat-sensitive recording sheet and use of the same

(75) Inventors: Jutta Berndt, Jarplund (DE); Matthias Marx, Nortorf (DE)

Correspondence Address: COHEN, PONTANI, LIEBERMAN & PAVANE, 551 FIFTH AVENUE, SUITE 1210, NEW YORK, NY, 10176, US

(73) Assignee: Mitsubishi HiTec Paper Flensburg GmbH

(21) Appl. No.: 11/998,246

(22) Filed: Nov. 29, 2007

Related U.S. Application Data
(63) Continuation of application No. 10/399,191, filed on Apr. 15, 2003, now abandoned.

(30) Foreign Application Priority Data
Oct. 16, 2006 (DE) 100 51 294.31

(51) Int. Cl. B41M 5/24

(52) U.S. Cl. 503/214

(57) ABSTRACT

The invention relates to a heat-sensitive recording sheet comprising a substrate, a heat-sensitive recording layer and a protective layer which is provided on the recording layer and which contains pigment. At least 80 wt. % of the pigment of the protective layer is formed from a highly purified bentonite treated with alkaline, the bonding agent of the protective layer consists of a water-insoluble, self-crosslinking acryl polymer, the bonding agent/pigment ratio is between 7:1 and 9:1, the crosslinking agent/bonding agent ratio is higher than 1:5, and the protective layer comprises Bekk smoothness of at least 900 seconds.

### CROSS REFERENCE TO RELATED APPLICATIONS

This application is a Continuation of U.S. patent application Ser. No. 10/399,191, filed Apr. 15, 2003, which is a National Stage of PCT No. PCT/EP01/11677 filed Oct. 9, 2001, which claims priority from application filed in Germany on Oct. 16, 2000, No. 100 51 294.1. The disclosure of U.S. patent application Ser. No. 10/399,191 is incorporated herein by reference.

### BACKGROUND OF THE INVENTION

1. Field of the Invention

The invention relates to a heat-sensitive recording sheet comprising a substrate, a heat-sensitive recording layer containing color formers and color acceptors, and a protective layer which is formed on the recording layer and contains a water-insoluble, self-crosslinking acrylic polymer as a binder, a crosslinking agent and a bentonite treated with alkali as a pigment, and its use as a ticket.

2. Description of the Related Art

A heat-sensitive recording sheet of the type stated at the outset is disclosed in WO 97-18091 A 1 and also in WO 98-43824 A 1. According to both publications, the protective layer of the known heat-sensitive recording sheet in each case also contains water-soluble binder in addition to water-insoluble binder. While, according to the teaching of the first publication, a pigment content of from 12 to 20% by weight, which may predominantly comprise bentonite digested with alkali, is to be provided, the total pigment content of the protective layer according to the teaching of the second publication is between greater than 20 and 40% by weight, from 15 to 30% by weight consisting of bentonite, in particular of a bentonite digested with alkali. According to the teaching of both publications, a crosslinking agent whose content-based on the total weight of the protective layer—is from 1 to 2% by weight in the case of the first publication and from 1 to 5% by weight in the case of the second publication may be contained in the protective layer.

U.S. Pat. No. 4,682,192 discloses a protective layer which serves for protecting a heat-sensitive recording layer applied to a substrate. The protective layer contains a colloidal inorganic silicate which is incorporated either as a mixture with a water-soluble or very sparingly water-soluble high molecular weight compound or in the absence thereof. The colloidal inorganic silicate is selected from colloidal magnesium aluminum silicates and fluorine-containing colloidal magnesium silicates, in particular bentonite, attapulgite and dimonite being disclosed. Further information on specific properties of the silicates is not disclosed in the publication. Self-crosslinking acrylic polymers are proposed as sparingly water-soluble high molecular weight compounds. The mixing ratio of said silicates and the sparingly water-soluble high molecular weight polymers is in general in the range between 1:0.1 and 1:10, a ratio between 1:1 and 1:5 being stated as a preferred range.

EP-A-0 344 705 discloses a protective layer in which from 0.5 to 3 parts by weight of pigment are present per part by weight of binder. Inter alia, polyvinyl alcohol, carboxymethylcellulose, starch and starch derivatives and copolymer emulsions of styrene-butadiene, vinyl acetate-ethylene, vinyl acetate-vinyl chloride-ethylene and methacrylate-butadiene are disclosed as suitable binders for the protective layer. Precipitated calcium carbonate, milled calcium carbonate, talc, kaolin, anhydrous silica, magnesium carbonate, zinc oxide, alumina and aluminum hydroxide are mentioned as suitable pigments, in addition to organic pigments. Pigment-containing protective layers which contain only water-soluble binder are described by way of example.

EP-B-0 373 903 relates to a heat-sensitive recording paper having an internal adhesive strength of 2.5 kg·cm or more, which has a protective layer which has a Bekk smoothness of at least 500 seconds, preferably of from 700 to 1500 seconds, and is applied to an intermediate layer containing fine particles of a styrene-acrylate polymer and a binder. Both water-soluble and water-insoluble high polymers having sufficient film formation capability are designated as binders suitable for the protective layer. An optional pigment addition to the protective layer is likewise disclosed, but the publication gives no information about the type of suitable pigments.

The known heat-sensitive recording papers have proven useful in numerous applications as office papers and also as tickets and labels, but there are constantly new fields of use which set new requirements for the recording papers used.

With the known use of heat-sensitive recording papers as lottery tickets, the demand grew for such papers which, under the influence of heat acting on them, can produce an inscription which comprises barcodes which are so crisp and have such a high ink density that they can be detected and analyzed without errors by means of a laser. To enable such a recording paper to be used as a lottery ticket, the barcode readability defined above must also be present when the lottery ticket has accidentally become wet. Since lottery tickets are frequently stored in plastic pockets to protect them from mechanical destruction, it is furthermore necessary for the heat-sensitive recording papers used in this manner to have high stability to plasticizers as usually used in plastic pockets. The necessity that a recording paper suitable for use as a lottery ticket must be capable of being economically produced should not be underestimated.

None of the known heat-sensitive recording papers have succeeded in completely meeting this range of requirements.

Since lottery tickets usually have imprints applied by means of flexographic or in particular by means of wet offset printing processes, the printability of the novel recording sheet is a further requirement which as far as possible is supplemented by its capability of being canceled.

### SUMMARY OF THE INVENTION

It is therefore an object of the present invention to provide a heat-sensitive recording sheet which, as a ticket and here in particular as a lottery ticket, guarantees outstanding barcode readability. The novel recording sheet must be distinguished by high environmental resistance, which, in the context of the invention, is to be understood as meaning the outstanding stability of the heat-sensitive recording sheet to water and to plasticizers. An important feature of the novel recording sheet must be its economical method of production.

The invention envisages a further object of developing a recording sheet which, in addition to the above-mentioned range of requirements, has good capability of being canceled and good printability in the flexographic and wet offset printing processes on its side provided with the heat-sensitive recording layer.

A heat-sensitive recording sheet has good capability of being canceled in the context of this invention if a cancellation stamp ink consisting of color-imparting pigments and not containing solvent cannot be wiped away completely from the recording sheet either in the dry state or in the wet state immediately after its imprint.

After intensive research work, the inventors have recognized that such a multiplicity of requirements, some of which are contradictory, can be ideally met by a heat-sensitive recording sheet which comprises
a substrate,
a heat-sensitive recording layer containing color formers and color acceptors and
a protective layer which is formed on a recording layer and contains a water-insoluble, self-crosslinking acrylic polymer as a binder, a crosslinking agent and predominantly a bentonite treated with alkali as a pigment,
the pigment of the protective layer consisting of one or more inorganic pigments and at least 80% by weight being formed from a highly purified bentonite treated with alkali,
the binder of the protective layer consisting of one or more water-insoluble, self-crosslinking acrylic polymers,
the binder/pigment ratio being in a range between 7:1 and 9:1,
the crosslinking agent/binder ratio being greater than 1:5 and
the protective layer having a Bekk smoothness of at least 900 seconds.

The numerical data disclosed in the description and patent claims in relation to the binder/pigment ratio and to the crosslinking agent/binder ratio relate to the respective % by weight, based on the protective layer.

The data given in the description and patent claims in relation to mass per unit area, % by weight and parts by weight relate in each case to the absolutely dry parts by weight.

The term “water-insoluble binders” used in the description and the patent claims is to be understood as meaning those binders which are present in the form of aqueous dispersions/latices of polymers or copolymers. In the context of the present invention, crosslinking agents are not included among the binders.

### DETAILED DESCRIPTION OF THE PRESENTLY PREFERRED EMBODIMENTS

The basis of the novel recording sheet is the highly purified bentonite which is treated with an alkali and is contained as an inorganic pigment, alone or in the mixing ratio according to the invention with other inorganic pigments, in the protective layer. The intrinsic adhesion of this bentonite requires a completely novel composition of the protective layer which is reflected in the ratio, according to the invention, of binder to pigment and crosslinking agent to binder. The choice of the binder is important in the context of the invention in that the production of a recording sheet which, after adjustment of its smoothness according to the invention, will meet all technological requirements is possible only by means of a self-crosslinking acrylic polymer as the sole binder and used in a specific ratio to the pigment on the one hand and crosslinking agent on the other hand. A self-crosslinking acrylic polymer in the context of this invention is to be understood as meaning a self-crosslinking binder selected from the group consisting of styrene-acrylic ester copolymer, a styrene/acrylic ester copolymer containing acrylamido groups and preferably a copolymer based on acrylonitrile, methacrylamide and acrylic ester. The smoothness of the novel recording sheet is achieved by its treatment with a smoothing apparatus, for example a calendar. Because of the fact that the protective layer of the novel recording sheet is in the form of a single layer, the subject of the invention can also fulfill the required commercial conditions.

With its binder/pigment ratio in a range between 7:1 and 9:1, the recording sheet according to the invention has a pigment content in the protective layer which, inter alia owing to the choice of the highly purified bentonite treated with alkali, as pigment, guarantee that the novel recording sheet will have both good capability of being canceled and good printability even in the case of protective layers having a relatively low mass per unit area, which can be explained, inter alia, by the large internal surface area and the large micropore volume of the highly purified bentonite treated with alkali.

In experimental series, it was found that natural or precipitated calcium carbonate, kaolin or titanium oxide also make a positive contribution to the improvement of the printing ink and stamp ink absorption, but the total content of bentonite relative to the other inorganic pigments must not fall below 80% by weight. In a further experimental series, it was also possible to demonstrate the positive influence of alumina and of aluminum-modified silica on the printing ink and stamp ink absorption, provided that here too the total content of bentonite relative to the other inorganic pigments does not fall below 80% by weight.

Through the choice of a water-insoluble, self-crosslinking acrylic polymer as binder and its ratio according to the invention, on the one hand to the pigment in a range between 7:1 and 9:1 and on the other hand to the crosslinking agent of greater than 5:1, high environmental resistance of the novel recording sheet is furthermore present even in the case of protective layers having a relatively low mass per unit area.

A decisive result of the intensive research work is, however, that the recording sheet according to the invention also guarantees the required outstanding barcode readability in addition to the properties explained above, which on the one hand is achieved by the high Bekk smoothness of greater than 900 seconds and, on the other hand, is promoted by the relatively low mass per unit area of the protective layer. In summary, it may be stated that only through the combination of all features of the recording sheet according to the invention which are stated in claim 1 is it possible to meet the entire range of requirements.

It has been found that particularly good results with respect to the object of this invention are achievable if the bentonite in powder form has surface/edge ratio in a range between 15 and 17, in particular in a range between 20 and 50.

In the course of the extensive experimental series, it emerged that convincing barcode readability in combination with high environmental resistance is present when the crosslinking agent/binder ratio is in a range between 1:5 and 1:40, preferably in a range between 1:5 and 1:20 or even better in a range between 1:5 and 1:10, very particularly advantageous experimental results being observable at a crosslinking agent/binder ratio in a range between 1:5 and 1:7.

In principle, the choice of the crosslinking agent is not important in the context of the invention, provided that crosslinking agent and binder do not adversely affect one another in the protective layer with respect to their actions. In the experimental work on which this invention is based, crosslinking agents used were in particular those which are selected from the group consisting of
cyclic urea,
methylolurea,
ammonium zirconium carbonate and
preferably polyamide/epichlorohydrin resin.

Starting from a Bekk smoothness of the protective layer of at least 900 seconds, a further increased barcode readability is obtained in the case of the recording sheet according to the invention if the protective layer has a Bekk smoothness in a range of from 1200 to 5500 seconds by means of strong calendering. It may be regarded as being a preferred embodiment of the invention when the protective layer has a Bekk smoothness in a range from greater than 1500 to 2500 seconds, since in this case a pleasant and particularly uniform appearance of the novel heat-sensitive recording sheet is obtained in addition to outstanding barcode readability and the meeting of all other technological and commercial requirements.

In order to achieve good barcode readability in the case of the novel recording sheet, the formation of the top layer with as low a mass per unit area as possible is desirable, but at the same time the contradictory requirements of high environmental resistance and good capability of being canceled and good printability in the flexographic and wet offset printing process must also be fulfilled. While the high environmental resistance requires a top layer having as high a mass per unit area and as high a content of binder and crosslinking agent as possible, the requirement for good capability of being canceled and good printability aims at a top layer having as high a mass per unit area and as high a pigment content as possible, which in particular contradicts good barcode readability. The inventors found that a recording sheet meeting all requirements set ideally has a mass per unit area of the protective layer in a range of from 1.0 to 4.0 g/m², preferably in a range of from 1.5 to 3.0 g/m² and very particularly preferably in a range of from 1.8 to 2.5 g/m².

For the purposes of the present invention, the stated protective layers can be applied to heat-sensitive recording layers which are applied directly to the substrate, for example comprising paper, but, according to a preferred embodiment, they can also be used in the case of those heat-sensitive recording sheets in which an intermediate layer which preferably contains oil-absorptive inorganic pigment is also formed between the substrate and the heat-sensitive recording layer. Such an intermediate layer can on the one hand make a positive contribution to the leveling of the substrate surface, with the result that the amount of coating slip which necessarily has to be applied for the heat-sensitive recording layer is reduced, and, on the other hand, the pigments of this intermediate layer take up the wax components of the heat-sensitive recording layer which are liquefied by the action of heat during the formation of the inscription and thus promote reliable and rapid functioning of the heat-induced recording.

The recording sheet according to the invention preferably has a backing coating which is applied to the substrate side which is opposite the side provided with the heat-sensitive recording layer. Such a backing coating is proposed, for example, in DE-A-197 48 258 and then serves for improved printability of the back of the recording sheet in the offset and flexographic printing process and an improved barrier effect of the back with respect to plasticizers, oils and fats.

The novel heat-sensitive recording sheet is designed in particular for use as a ticket and here especially for use as a lottery ticket. Frequently, recording sheets used in this manner have to meet the requirement that their authenticity can be proven in a simple manner and as far as possible without the use of complicated aids. In one embodiment which meets this requirement, the novel recording sheet has a security feature or a combination of a plurality of security features. Possible security features are in particular the following authenticity-proving components also disclosed in the non-prior-published DE 199 36 030, without being limited or specified neither in type nor in number to be combined:
a water-insoluble dye (A) which is invisible to the naked eye and is incorporated into the substrate and which, when the surface is wetted with an organic solvent or an acid, produces a striking color at least on the side which is opposite the side provided with the heat-sensitive recording layer;
a dye (B) which is only slightly visible in the acidic or neutral pH range in daylight and is applied in a regular or irregular pattern over the total area of the side which is opposite the side provided with the heat-sensitive recording layer and, in contact with an alkaline substance, undergoes a color reaction which leads to a stable color fluorescent in daylight;
a watermark incorporated in or printed on the substrate;
a pulp introduced into the substrate, colored with a dye (C) and/or treated with an optical brightener and fluorescing under UV irradiation;
an SC layer which is applied to the side which is opposite the side provided with the heat-sensitive recording layer and in which acceptors and microcapsules with color formers encapsulated therein are present, the color formers undergoing a color-forming reaction with the acceptors under pressure.

A pigmented intermediate layer which is designed according to a proposal of the non-prior-published DE 100 21 896 for the formation of authenticity-proving marks in locally different thickness is also possible as a security feature for the novel recording sheet.

It is furthermore preferable if the protective layer contains a metal salt of a long-chain fatty acid, in particular stearic acid, as a lubricant. A very particularly preferred lubricant in the protective layer is a zinc stearate, preferably in an amount of less than 20, in particular less than 15, parts by weight, based on, altogether, 100 parts by weight of the protective layer.

The protective layer is produced using an aqueous coating slip which, in addition to said pigments, binders, crosslinking agents and lubricants, also contains customary coating slip auxiliaries and additives, such as, for example, dispersants, antifoams and metal salts for accelerating the crosslinking by the crosslinking agent, in an amount of these coating slip auxiliaries, together, of not more than 10 parts by weight, preferably not more than 7 parts by weight, based on, altogether, 100 parts by weight of the protective layer.

The following example will further illustrate the invention:

A paper web of bleached and beaten hardwood and softwood pulps having a mass per unit area of 67 g/m² is produced on a Foudrinier paper machine with addition of customary additives in customary amounts. An 8 g/m² intermediate layer comprising calcined kaolin as pigment, styrene/butadiene latex as binder and starch as cobinder in addition to further auxiliaries is applied to the front.

A heat-sensitive recording layer containing color formers and color acceptors and having a mass per unit area of 5.4 g/m² is applied to the intermediate layer.

A 2 g/m² protective layer is applied to the dried recording layer. The pigment used is a highly purified bentonite which is treated with alkali and has a lamellar structure and whose intrinsic adhesion permits its fixing with a low binder requirement and whose specific surface area in the undispersed state is given as 85 m²/g with a surface/edge ratio which, in the case of the bentonite present in powder form, varies in a range between 20 and 50. A binder/pigment ratio of 6:1 and a crosslinking agent/binder ratio of 1:5 are established. A polyamide/epichlorohydrin resin is used as the crosslinking agent, and the aqueous dispersion of a self-crosslinking polymer of acrylonitrile, methacrylamide and acrylic ester is used as the binder. The coating slip for the production of the protective layer contains, as further components, an antifoam, stearic acid as a lubricant and various dispersants on the one hand for the pigment and on the other hand for the lubricant.

The applied coating slip is dried and the recording sheet produced so far is smoothed by means of a calendar, a Bekk smoothness of 2200 seconds being achieved.

The recording sheet which is produced in this manner and which is economically produced compared with its requirement profile can be readily printed on in the flexographic and in the wet offset printing process and has good capability of being canceled.

The water resistance is determined as the ratio of two measurements of the dynamic print density determined with the aid of the Macbeth RD 914 from Karl Schröder KG (Korrillonstrasse 32, D-69469 Weinheim). For this purpose, a sample of the recording sheet according to the invention is provided with an inscription using a thermal printer of the type TP 3000-300 from Charles Richiger A G, Maschinenbau (Bernstrasse 81, CH-3613 Steffisburg). After a first measurement of the dynamic print density, the sample of the recording sheet according to the invention is immersed in water for 60 minutes. The dynamic print density is then measured a second time. The water resistance of the recording sheet according to the invention, investigated in this manner, is to be regarded as very good with a quotient of the two measured values of 94%. The novel recording sheet is provided with a heat-induced barcode using a 300 dpi BOCA printer, type Micro 21, from Boca tickets & printers (Vlietweg 17, NL-2266 KA Leidschendam). The printed image is inspected visually and rated as good with respect to its crispness and ink density.

What is claimed:

1. A heat-sensitive recording sheet, comprising:
a substrate;
a heat-sensitive recording layer containing color formers and color acceptors; and
a protective layer which is formed on the recording layer and includes a binder, a crosslinking agent, and a pigment comprising predominantly a bentonite treated with alkali,
wherein the pigment of the protective layer consists of one or more inorganic pigments and at least 80% by weight of the pigment being formed from a highly purified bentonite treated with alkali, the binder of the protective layer consists of one or more water-insoluble, self-crosslinking acrylic polymers, the binder/pigment ratio is in a range between 7:1 and 9:1, the crosslinking agent/binder ratio is greater than 1:5, and the protective layer has a Bekk smoothness of at least 900 seconds.

2. The recording sheet of claim 1, wherein the pigment contains at least one further inorganic pigment selected from the group consisting of natural or precipitated calcium carbonate, kaolin, titanium oxide, alumina and aluminum-modified silica.

3. The recording sheet of claim 1, wherein the bentonite in powder form has a surface/edge ratio in a range between 15 and 70.

4. The recording sheet of claim 1, wherein the crosslinking agent/binder ratio is in a range between 1:5 and 1:40.

5. The recording sheet of claim 1, wherein the crosslinking agent/binder ratio is in a range between 1:5 and 1:10.

6. The recording sheet of claim 1, wherein the crosslinking agent/binder ratio is in a range between 1:5 and 1:7.

7. The recording sheet of claim 1, wherein the crosslinking agent is selected from the group consisting of cyclic urea, methylolurea, polyamide/epichlorohydrin resin and ammonium zirconium carbonate.

8. The recording sheet of claim 1, wherein the protective layer has a Bekk smoothness in a range from 1,200 to 5,500 seconds.

9. The recording sheet of claim 1, wherein the protective layer has a Bekk smoothness in a range from greater than 1,500 to 2,500 seconds.

10. The recording sheet of claim 1, wherein the mass per unit area of the protective layer is in a range from 1.5 to 3.0 g/m².

11. The recording sheet of claim 1, further comprising a pigment-containing intermediate layer formed between the substrate and the heat-sensitive recording layer.

12. The recording sheet of claim 1, wherein the substrate has a backing coating on the side opposite the heat-sensitive recording layer.

13. The recording sheet of claim 1, further comprising at least one security feature allowing authentication of the recording sheet.

14. The recording sheet of claim 13, wherein the at least one security feature is selected from the group of security features consisting of:
a water-insoluble dye which is invisible to the naked eye and is incorporated into the substrate and which, when the surface of the substrate is wetted with an organic solvent or an acid, produces a striking color at least on the side of the substrate opposite the heat-sensitive recording layer,
a further dye which is only slightly visible in the acidic or neutral pH range in daylight and is applied in a regular or irregular pattern over the total area of the side of the substrate opposite the heat-sensitive recording layer and, in contact with an alkaline substance, undergoes a color reaction which leads to a stable color fluorescent in daylight,
a watermark incorporated in or printed on the substrate,
a pulp introduced into the substrate, at least one of colored with a third dye and treated with an optical brightener, the pulp fluorescing under UV irradiation,
a layer which is applied to the side of the substrate opposite the heat-sensitive recording layer and in which acceptors and microcapsules with color formers encapsulated therein are present, the color formers undergoing a color-forming reaction with the acceptors under pressure, and
a pigmented intermediate layer arranged for the formation of authenticity-proving marks in locally different thickness.

15. The recording sheet of claim 1, wherein the recording sheet is a ticket.
